(19) United States
(12) Patent Application Publication
(10) Pub. No.: US 2008/0078500 A1
(43) Pub. Date: Apr. 3, 2008

(54) METHOD OF MANUFACTURING STRUCTURED RELEASE LINER

(75) Inventors: Frank T. Sher, St. Paul, MN (US); David J. Yarusso, Shoreview, MN (US); Brian E. Spiewak, Inver Grove Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/537,736

(22) Filed: Oct. 2, 2006

(51) Int. Cl. B32B 37/00

(52) U.S. Cl. 156/289; 156/244.11

(57) ABSTRACT

Disclosed herein is a method of manufacturing a structured release liner. The method includes providing an extrudable material; extruding the extrudable material through a die having a profile thereby forming a base and at least one rail. The rail has a height over the base of less than 100 micrometers. In other embodiments, a first and second extrudable material are provided and are extruded through the die to create a first layer and a second layer. The structured release liner may also be formed by extruding onto an existing substrate. Also disclosed herein is a method of forming a laminate construction comprising an adhesive layer and a backing.

### FIELD

The present application is directed to a method of manufacturing structured release liners, and particularly, to an extrusion process that employs a die having a profile for forming structured release liners.

### BACKGROUND

Pressure sensitive adhesives are useful for the joining of two materials. The interfaces between the adhesive and the materials are vital to the performance of the joined materials. The loss of adhesion at either interface can doom the usage of the materials. Adhesives have been structured in the past for various reasons.

Several approaches to structuring adhesives are known, including those shown in, for example, U.S. Pat. Nos. 5,296,277 and 5,362,516 (both Wilson et al.); U.S. Pat. Nos. 5,141,790 and 5,897,930 (both Calhoun et al.); and U.S. Pat. No. 6,197,397 (Sher et al.). These patents disclose how the structure in the adhesive is built from the interface between the adhesive and the release liner.

These release liners are generally manufactured by structuring a thermoplastic polymer surface of the liner. Current methods of making release liners having microstructured patterns include cast extrusion onto a microstructured tool that imparts the desired pattern to the liner followed by silicone release coating where required, or by embossing. i.e. pressing, a pattern into a thermoplastic polymer surface, with or without a silicone release coating, between structured nips to impart a pattern. These manufacturing steps form the topography on the liner, which is then used to impart topography into an adhesive. These steps require durable patterned tools, appropriate equipment, and materials suitable for these processes that can provide stable topography for further processing and use.

### SUMMARY

Disclosed herein is a method of manufacturing a structured release liner. The method includes providing an extrudable material; extruding the extrudable material through a die having a profile thereby forming a base and at least one rail. The rail has a height over the base of less than 100 micrometers. In other embodiments, a first and a second extrudable material are provided and are extruded through the die to create a first layer and a second layer.

The structured release liner may also be formed by extruding the base and the rails onto an existing substrate. That is, the method of manufacturing a structured release liner may comprise: providing an extrudable material; providing a substrate; extruding the extrudable material through a die having a profile thereby forming the base and at least one rail on the substrate, and each rail having a height over the base of less than 100 micrometers.

Laminate constructions comprising adhesive layers disposed on the structured release liners are also described. The adhesive layer is structured by the structured release liner, and the structured adhesive thus formed may then be separated from the structured release liner. The structured adhesive may be used in a variety of applications, including applications in which microstructured adhesive films are employed.

These and other aspects of the invention will be apparent from the detailed description below. In no event, however, should the above summary be construed as a limitation on the claimed subject matter, which subject matter is defined solely by the attached claims, as may be amended during prosecution.

### BRIEF DESCRIPTION OF THE DRAWINGS

FIG. 1 a shows an elevated view of an exemplary structured release liner.

FIGS. 1b to 1d show a cross-sectional view of exemplary structured release liners.

FIGS. 2a-2c show cross-sectional views of exemplary structured release liners.

FIGS. 3a and 3b show cross-sectional views of exemplary laminate constructions formed using the structured release liner of FIGS. 1a and 1b.

FIG. 4 shows a cross-sectional view of a structured adhesive film formed from the laminate construction of either FIG. 3a or 3b.

### DETAILED DESCRIPTION

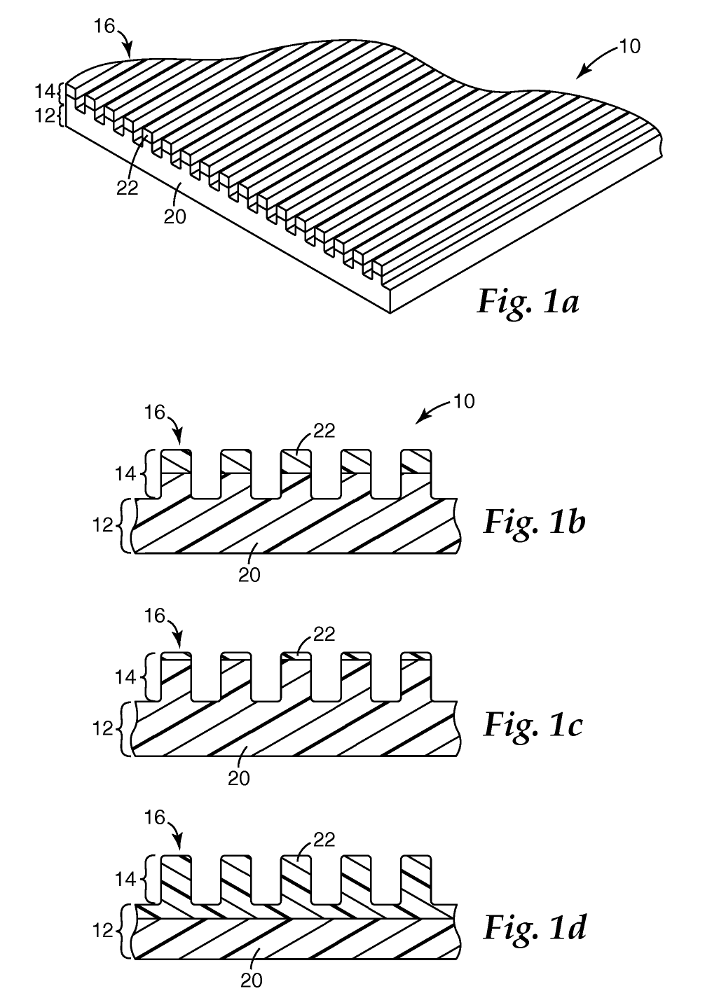

FIG. 1a shows an elevated view of exemplary structured release liner 10 comprising base 12 and rails 14. The rails form structured surface 16. FIG. 1b shows a cross sectional view of the structured release liner shown in FIG. 1a. The structured release liner of the present application may be manufactured by extruding first and second extrudable materials through a die having a profile thereby forming first layer 20 and second layer 22, respectively. In general, the first and second layers are contiguous and together the layers form the rails and the base. In general, the layer or layers are extruded in a softened state and then quenched, for example in a water bath, forming the structured release liner.

In some cases, extrudable material is extruded through a die having a profile onto an existing substrate. In such an embodiment, the base and the rails are formed on the existing substrate. Examples of suitable existing substrates include, for example, paper, poly(ethylene terephthalate), or polyolefin film such as polyethylene or polypropylene. The existing substrate may be primed or treated to enhance the adhesion of the first extrudable material and the resulting structure. Examples of such treatments include, for example, corona, flame, plasma and chemical treatments.

The structured release liner may comprise a single material, e.g., the base and the rails are the same extrudable material. The structured release liner may also comprise multiple materials, each one different from the other, such that the structured release liner comprises a multilayer structure. For example, the structured release liner may comprise different first and second extrudable materials such that the base comprises a multilayer structure. For another example, the structured release liner may comprise different first and second extrudable materials such that the rails each comprise a multilayer structure.

As shown in the cross-sectional views of FIG. 1b and FIG. 1c, the thickness of the first and second layers may be such that each rail comprises a fraction of the first layer and the second layer, and the base comprises the first layer. Similarly, the thickness of the second layer may be greater than that of the rail height such that each rail comprises only the second layer as shown, for example, in FIG. 1d, and the base comprises the first and second layers. Another example is one in which the base comprises substantially the first layer, and each rail comprises substantially the second layer (not shown). In all embodiments, the extrudable materials may be extruded onto an existing substrate.

The extrusion process generally produces molecular orientation in the extruded material. Generally, the extruded material, be it the entire structured release liner or merely the rails, is oriented down-web and along the rail. For example, if the rail is at zero (0) degrees, the polymer backbone chain axis of the extruded material is generally oriented 0-45 degrees (down-web) versus 45-90 degrees (cross-web).

The structured release liner may be subjected to post-extrusion processing. Post-extrusion processing may involve for example a curing step that could include one or more of thermal, electromagnetic radiation (for example ultraviolet light, visible light and microwave), and particle radiation (for example e-beam exposure).

The rails may have a height over the base of less than about 100 micrometers, for example less than about 50 micrometers, or less than about 30 micrometers. Generally, the rails have a height over the base of at least about 3 micrometers. The rails may have a width at the widest point when viewed as a cross-section of less than about 300 micrometers, for example less than about 200 micrometers, or less than about 150 micrometers. The rails may have a width greater than about 15 micrometers, for example greater than about 25 micrometers, or greater than about 50 micrometers. The rails may be wider than they are high, or the width and the height may be substantially equivalent. Or, the rails may be higher than they are wide. The height of any rail is the difference between the top of the rail and the average plane of the surface between adjacent rails.

The structured release liner comprises a rail, and generally comprises multiple rails that extend in a substantially parallel relationship with respect to one another in a single direction along the base. Each rail is substantially continuous along the entire length of the base to an edge of the base.

The structured surface may be a defined pattern comprising at least one continuous structure from one edge of the base to a second edge of the base. The pattern may form any shape possible to be manufactured using a profile die extrusion process.

In embodiments having more than one rail, the pitch, defined as the distance between the center points of adjacent shapes, is generally greater than about 150 micrometers, for example greater than about 170 micrometers, or greater than about 200 micrometers. The pitch is generally less than 5100 micrometers, for example less than about 2500 micrometers, or less than about 1700 micrometers.

The rails may have any shape when viewed in cross section, for example, square, triangular, rectangular, diamond, hexagonal, semi-circular, trapezoidal, etc. FIGS. 1a-1d illustrate rails that are rectangular, and FIGS. 2a-2c show rails with different shapes, 26a-26c, respectively.

In general, the extrudable material is a thermoplastic material that is capable of being extruded. Specific examples of extrudable materials include polyester (for example polyethylene terephthalate), polyurethanes, polyethylene, and polypropylene. The extrudable material may also comprise several materials to form a blend. In embodiments comprising multiple layers, more than one extrudable material may be used to form the multiple layers.

As described below, an adhesive such as an adhesive layer may be contacted with the structured surface of the structured release liner. In some embodiments, a backing may then optionally be applied to the adhesive layer opposite the structured release liner. In other embodiments, another release liner (either structured or unstructured), an article or substrate may then optionally be applied to the adhesive layer opposite the structured release liner. In some embodiments, the adhesive layer surface opposite the structured release liner is left exposed, and the adhesive and release liner may then be rolled, so that the adhesive surface opposite the structured release liner is then in contact with the surface of the structured release liner opposite the adhesive. Such a surface on the structured release liner may be structured or unstructured. The adhesive layer may then be separated from the structured release liner, resulting in a structure formed on the adhesive layer. This structure is the inverse of that of the structured surface of the structured release liner. The structure formed on the adhesive layer may form air egress channels such that when in contact with a substrate, the air egress channels define a structured bonding surface having exit pathways for air to bleed out from under the adhesive layer when the structured surface of the adhesive layer is adhered to a substrate. The structured adhesive layer and the optional backing may be referred to as a structured adhesive film.

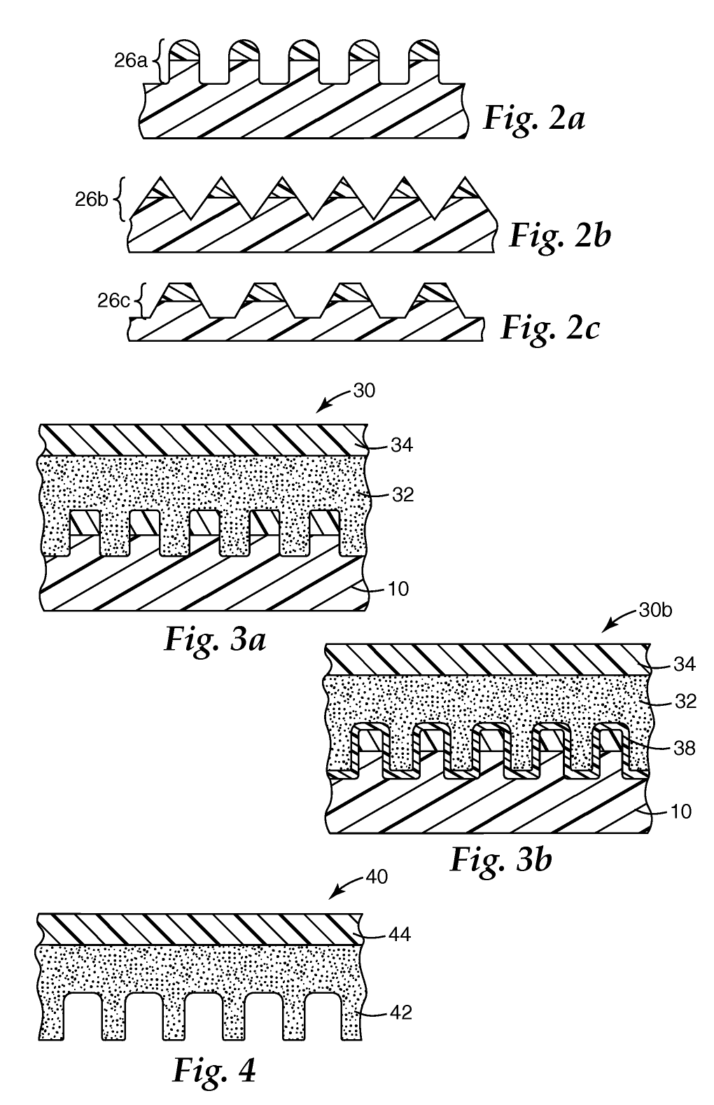

FIGS. 3a and 3b show exemplary laminate constructions 30 and 30b, respectively, that may be formed using the structured release liner of FIG. 1. In FIG. 3a, adhesive layer 32 is disposed on the structured surface of structured release liner such as shown in FIG. 1b, and backing 34 is disposed on the adhesive layer opposite the liner. In this case, the structured release liner may have intrinsic release properties such that the resulting structured adhesive layer could be separated with little or no damage from the liner. In FIG. 3b, release layer 38 is disposed between the liner and the adhesive layer. The release layer facilitates release of the resulting structured adhesive layer with little or no damage from the liner.

The extrudable material may comprise a release material in order to facilitate separation of the structured release liner from the structured adhesive. In embodiments comprising at least two layers, the release material may be in only the second layer (i.e. element 22 in FIGS. 1a-1d), the layer that will be in contact with an adhesive. Alternatively or in addition thereto, the release material may be coated on the structured surface such that a release layer is formed as described above.

Examples of suitable release materials include silicones which may be radiation curable silicones, such as those described in U.S. Pat. No. 5,527,578 and U.S. Pat. No. 5,858,545, and other reactive silicones, such as those described in WO 00/02966, the disclosures of which are incorporated herein by reference. Specific examples include polydiorganosiloxane polyurea copolymers and blends thereof, such as those described in U.S. Pat. No. 6,007,914, the disclosure of which is incorporated herein by reference. Examples of release coatings include silicone, solvent and solventless types, thermal cure and radiation cure types, condensation cure types and addition cure types, epoxide functional, acrylate functional, silanol functional types, silicone hydride functional types, and release modifiers, such as siloxanes. Another example of a suitable release material that may be incorporated into the extrudable material or coated as a release material is a fluorocarbon material.

Other additives in the extrudable material can include dispersants, colorants, catalysts and surface tension modifiers.

In another embodiment, the structured release liner may comprise release functionality on both sides so that the structured release liner and structured adhesive may be wound into a roll to form a transfer tape. The release liner may also be structured on both sides such that in the form of a transfer tape, the adhesive will be structured on both sides. In embodiments comprising an adhesive layer between two liners, one or both liners may be structured on the side in contact with the adhesive.

The adhesive layer may be made by coating an adhesive dissolved or dispersed in a solvent onto the structured surface, or a hot melt adhesive may be used by coating it in a molten state onto the structured surface and then cooling it to form the adhesive layer. A backing may then be applied to the adhesive layer opposite the structured surface. An adhesive layer may also be formed by laminating an existing adhesive layer to the microstructured liner surface. The existing adhesive layer may be in the form of an adhesive film comprising an adhesive layer disposed on a backing. The adhesive layer may be disposed on a release liner, an article or a substrate. The method may further comprise crosslinking the adhesive such as with any of the curing means described above, depending on the particular components in the adhesive.

The adhesive is generally a pressure sensitive adhesive. Pressure sensitive adhesives are generally characterized by their properties. Pressure sensitive adhesives are well known to one of ordinary skill in the art to possess properties including the following: (1) permanent tack, (2) adherence to an adherend with no more than finger pressure, (3) sufficient ability to hold onto an adherend, and (4) sufficient cohesive strength to meet the needs of an intended application. Many pressure sensitive adhesives must satisfy these properties under an array of different stress rate conditions.

The pressure sensitive adhesive may be any of those based on natural rubbers, synthetic rubbers, styrene block copolymers, polyvinyl ethers, poly(meth)acrylates (including both acrylates and methacrylates), polyolefins, and silicones. The pressure sensitive adhesive may be water or solvent based, a hot melt type, or a 100% solids coatable type. Furthermore, the pressure sensitive adhesive may comprise a single pressure sensitive adhesive or a combination of two or more pressure sensitive adhesives.

Useful poly(meth)acrylic pressure sensitive adhesives are derived from, for example, at least one alkyl(meth)acrylate ester monomer such as, for example, isooctyl acrylate, isononyl acrylate, 2-methyl-butyl acrylate, 2-ethyl-hexyl acrylate and n-butyl acrylate; and at least one optional co-monomer component such as, for example, (meth)acrylic acid, vinyl acetate, N-vinyl pyrrolidone, (meth)acrylamide, a vinyl ester, a fumarate, a styrene macromer, or combinations thereof. Preferably, the poly(meth)acrylic pressure sensitive adhesive is derived from between about 0 and about 20 weight percent of acrylic acid and between about 100 and about 80 weight percent of at least one of isooctyl acrylate, 2-ethyl-hexyl acrylate, or n-butyl acrylate. For example, the poly(meth)acrylic pressure sensitive adhesive may be derived from between about 2 and about 10 weight percent acrylic acid and between about 90 and about 98 weight percent of at least one of isooctyl acrylate, 2-ethyl-hexyl acrylate, or n-butyl acrylate. Another example comprises from about 2 weight percent to about 10 weight percent acrylic acid, and about 90 weight percent to about 98 weight percent of isooctyl acrylate. For yet another example, the adhesive is derived from between about 94-98 weight percent of isooctyl acrylate, 2-ethyl hexyl acrylate, n-butyl acrylate, or 2-methyl butyl acrylate, and 2-6 weight percent (meth)acrylamide.

Additives to the pressure sensitive adhesive may be used to impart, control, adjust, etc. desired properties such as tackiness and cohesive strength. For example, tackifiers and/or detackifiers may be used; for example, useful tackifiers include rosin ester resins, aromatic hydrocarbon resins, aliphatic hydrocarbon resins, and terpene resins. Other materials can be added for special purposes, including, for example, oils, plasticizers, fillers, antioxidants, UV stabilizers, hydrogenated butyl rubber, pigments, and curing agents.

The adhesive can be solvent coated, for example in water or organic solvents. In other embodiments, the adhesive is hot melt coated. In other embodiments, the adhesive may be coated out as a 100% solids composition and then cured.

The backing may be paper or any film, for example graphic films such as polyvinyl chloride. The backing may be imaged using any commercial technique, including electrophotography, electrostatic printing, inkjet printing, screen printing, flexography, electronic cutting, or other imaging or graphic techniques. Contacting a backing to the adhesive layer may comprise laminating the backing to the adhesive layer already formed on the structured release liner, or the adhesive layer may be formed on the backing and then the adhesive layer contacted with the structured surface of the structured release liner. In this latter case, the backing with the adhesive layer already formed thereon may be an adhesive film such as a tape.

FIG. 4 shows an exemplary structured adhesive film 40, with adhesive layer 42 and backing 44, that may be formed by separating the adhesive layer/backing from the structured release liners of FIG. 1a or 1b. Structured adhesive films may be laminated to an adherend or surface by hand, with the use of a squeegee or roller, or other conventional techniques.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

### Table of Abbreviations

| Abbreviation | |
|---|---|
| or Trade | |
| Designation | Description |
| PP | Impact modified polypropylene commercially available as |
| | “7C55H” from Union Carbide, Danbury, CT |
| Additive | A 50:50 mixture by weight of silicone “MB50-001” |
| | commercially available from Dow Corning, Midland, |
| | MI and PP. |
| Adhesive | Adhesive coated graphic film commercially available as |
| Film | “SCOTCHCAL Graphic Marking Film 1330-526” from 3M |
| | Company, St. Paul, MN. |
| MEK | methyl ethyl ketone |
| PSA solution | A 25% solids solution in ethyl acetate of a 93:7 iso-octyl |
| | acrylate/acrylic acid PSA containing 0.4 parts of bisamide |
| | crosslinker described in U.S. Pat. No. 5,296,277 (Wilson |
| | et al.) as Adhesive Solution 5 diluted to 25% solids |
| | with ethyl acetate. |
| PVC | Primed polyvinyl chloride film of 51 micrometers (2 mils) |
| | thickness commercially available from 3M Company, |
| | St. Paul, MN. |

### Test Methods

### Surface Energy

The surface energy of the flat face of film samples was determined by calculating the dispersion and polar contributions based on the advancing contact angles of hexadecane and water, using mathematical approximations of D. H. Kaelble as described, for example, in Dispersion-Polar Surface Tension Properties of Organic Solids, J. Adhesion, Volume 2, April 1970, p 66. A Rame-Hart Model 100-00 115 Goniometer (commercially available from Rame-Hart Instrument Co., Netcong, N.J.) was used to determine the advancing contact angles using water and hexadecane. For the calculation, the surface tension of water was taken as 72.8 dyne/cm with the dispersion component taken as 21.8 dyne/cm and the polar component taken as 51.0 dyne/cm. The surface tension of hexadecane was taken as 27.6 dyne/cm, all being attributed to the dispersion component. Surface energies were calculated in ergs/cm² and converted to Newtons/meter.

### Wet Out Test

Wet out of critical wetting tension dyne solutions (commercially available from Jemmco, LLC, Mequon, Wis.) with values of 0.033 to 0.030 Newtons/meter (33 to 30 dynes/cm), was evaluated on the flat face of film samples. Samples were rated as “Wet” if the solution was observed to wet the film or “Dewet” if the solution was observed to not wet the film.

### WYKO Analysis

Adhesive samples were evaluated using interferometry microscopy using a WYKO RST surface profiler (WYKO Corp., Tucson, Ariz.). This technique used light interferometry to evaluate the surface topography of a sample. Light was reflected from essentially horizontal surfaces, and thus the dimensions of the rails could be determined.

### Indent Panel Test

A circular indent was made in 0.7 mm thick aluminum test panel using a hemispherical drop hammer with a tip diameter of 2.5 cm. The indent was about 2.8 cm diameter at the plane of the panel and was about 0.6 cm deep. A 7.5 cm by 7.5 cm test sample to be tested was centered over the indent and applied flat onto the panel and taut over the indent. A PA-1 Hand Applicator with a protective sleeve (SA-1, available from 3M) was used to press the sample onto the panel using a mass of about 1 kg. Then the film was pressed with a thumb into the depressed indent. At least 3 kg of mass was applied. The ability of the sample to conform into the indent and uniformly contact the depressed panel indent was rated as follows:
0—would not conform significantly into the indent against the entrapped air;
1—could be pressed down into the indent to the extent of about 50%;
2—could be pressed down to conform with much of the indent leaving small air bubbles;
3—could be pressed down to conform slowly (greater than 5 seconds) and completely into the indent;
4—could be pressed down to conform swiftly (less than 5 seconds) and completely into the indent.

### EXAMPLES 1 and 2 AND COMPARATIVE EXAMPLE C1

Profile extruded films of PP (Comparative Example C1) and PP and Additive (Examples 1 and 2) with a width of 19 centimeters (7.5 inches) were prepared using a 6.4 centimeter (2.5 inch) Davis-Standard Single Screw Extruder with a 20 centimeter (8 inch) die having wire cut parallel semicircular grooves with the dimensions of 25 micrometers (1 mil) deep, 152 micrometers (6 mils) pitch, and 66 lines per centimeter (167 lines per inch). The extruder temperatures were: Zone 1 177° C. (350° F.); Zone 2 204° C. (400° F.); Zone 3 232° C. (450° F.); Zone 4 232° C. (450° F.) and the Die Block temperature was 232° C. (450° F.); with a screw turning rate of 5 RPM giving an extrusion rate of 3 meters/minute (10 feet/minute) giving a caliper of 114 micrometers (4.5 mils). There was a 16° C. (60° F.) cooling water bath within 1.3 centimeters (0.5 inch) of the die block. The amount of Additive used is shown in Table 1. The surface energy and wet out of the flat face of each film was determined as described in the test methods above, and the results are shown in Table 1. An Adhesive Film was removed from its paper liner and the adhesive layer adhered firmly onto the structured side of the three extruded film samples using a 3M PA-1 plastic squeegee. The adhesive films were then manually peeled off of the extruded liner samples. The manual peel results are shown in Table 1.

TABLE 1

| | Addi- | | | | | | |
|---|---|---|---|---|---|---|---|
| | tive | Surface | Wet out Solution | | | | Manual |
| | Amount | Energy | 0.033 | 0.032 | 0.031 | 0.030 | Peel |
| Ex. | (wt. %) | (N/m) | (N/m) | (N/m) | (N/m) | (N/m) | Results |
| C1 | 0 | 0.0285 | Dewet | Wet | Wet | Wet | shocky |
| | | | | | | | stick-slip |
| | | | | | | | peel |
| 1 | 5 | 0.0270 | NM | Dewet | Dewet | Dewet | smooth |
| 2 | 15 | 0.0268 | NM | Dewet | Dewet | Dewet | smooth, |
| | | | | | | | only |
| | | | | | | | moderate |
| | | | | | | | resistance |

NM = not measured

### EXAMPLE 3

A sample of the film prepared in Example 2 was coated with a thin layer of a silicone release solution using a Number 5 Mayer rod and oven dried for 2 minutes at 104° C. followed by room temperature post cure for one day. The release solution was a mixture containing 18.2 grams of heptane, 4.6 grams of MEK, 4.0 grams of SYL-OFF 292 silicone polymer (commercially available from Dow Corning, Midland, Mich), 0.11 grams of SYL-OFF 297 anchorage additive (commercially available from Dow Corning, Midland, Mich.,), 0.11 gram of SYL-OFF C4-2117 fast cure additive (commercially available from Dow Coming, Midland, Mich.), and 0.17 gram of SYL-OFF 176 tin catalyst (commercially available from Dow Corning, Midland, Mich.). The release-coated film was coated with the PSA Solution at nominal 178 micrometers (7 mils) wet thickness and oven dried at 71° C. for 10 minutes.

A film backing of PVC was laminated to the dried adhesive. The film backing/PSA sample was removed smoothly and easily from the liner. WYKO analysis showed a linear channel pattern on the PSA surface corresponding to the general ridge profile of the liner, with surface channel depths up to 11 micros and pitch of about 150 micros (6 mils). With the profile extruded release liner removed, a sample of the laminate was applied to a flat panel such that entrapped air pockets were purposely formed under the applied sample away from the edges and making elevated regions near the center of the applied sample. Pressing by hand on and near the elevated regions of the applied film sample flattened the entire laminate against the panel by pressing out the air pockets via fluid egress in the channels to edges. Air bleed was also demonstrated using the general procedure of the Indent Panel Test described above, which gave a rating of 1.

Various modifications and alterations of the present invention will become apparent to those skilled in the art without departing from the spirit and scope of the invention.

What is claimed is:

1. A method of forming a structured release liner, the method comprising:
providing an extrudable material;
extruding the extrudable material through a die having a profile thereby forming a base and at least one rail on the base wherein the rail has a height over the base of less than 100 micrometers.

2. The method of claim 1 comprising providing a first and a second extrudable material and extruding the first and second extrudable materials through the die to create a first layer and a second layer.

3. The method of claim 2, wherein each rail comprises the first and second layers, and the base comprises the first layer.

4. The method of claim 2, wherein each rail comprises the second layer, and the base comprises the first and second layers.

5. The method of claim 2, wherein each rail comprises substantially the second layer, and the base comprises substantially the first layer.

6. The method of claim 1, wherein each rail has a height over the base of less than 50 micrometers.

7. The method of claim 1, wherein each rail has a height over the base of less than 30 micrometers.

8. The method of claim 1, wherein the extrudable material comprises a silicone or fluorocarbon release material.

9. A method of forming a laminate construction, the method comprising:
providing the structured release liner of claim 1, wherein the rails form a structured surface; and
contacting an adhesive on the structured surface to form an adhesive layer on the structured surface.

10. The method of claim 9 wherein the contacting step comprises coating the adhesive onto the structured surface.

11. The method of claim 9 wherein the contacting step comprises laminating the adhesive to the structured surface.

12. The method of claim 9 comprising contacting a backing to the adhesive layer opposite the structured surface.

13. The method of claim 9 comprising contacting a second release liner to the adhesive layer opposite the structured surface.

14. The method of claim 13 wherein the second release liner has a structured surface.

15. The method of claim 1, wherein the rail forms a structured surface, the method further comprising:
coating a silicone or fluorocarbon release material over the structured surface to form a release layer.

16. A method of forming a structured release liner, the method comprising:
providing an extrudable material;
providing an existing substrate;
extruding the extrudable material through a die having a profile thereby forming a base and at least one rail on the existing substrate, and each rail having a height over the base of less than 100 micrometers.

17. The method of claim 16 comprising providing a first and a second extrudable material and extruding the first and second extrudable materials through the die to create a first layer and a second layer.

18. The method of claim 17, wherein each rail comprises the first and second layers, and the base comprises the first layer.

19. The method of claim 17, wherein each rail comprises the second layer, and the base comprises the first and second layers.

20. The method of claim 17, wherein each rail comprises substantially the second layer, and the base comprises substantially the first layer.

21. The method of claim 16, wherein each rail has a height over the base of less than 50 micrometers.

22. The method of claim 16, wherein each rail has a height over the base of less than 30 micrometers.

23. The method of claim 16, the extrudable material comprising a silicone or fluorocarbon release material.

24. A method of forming a laminate construction, the method comprising:
providing the structured release liner of claim 16, wherein the rail forms a structured surface; and
contacting an adhesive on the structured surface to form an adhesive layer.

25. The method of claim 24 wherein the contacting step comprises coating the adhesive onto the structured surface.

26. The method of claim 24 wherein the contacting step comprises 1a minating the adhesive to the structured surface.

27. The method of claim 24 comprising contacting a backing to the adhesive layer opposite the structured surface.

28. The method of claim 24 comprising contacting a second release liner to the adhesive layer opposite the structured surface.

29. The method of claim 28 wherein the second release liner has a structured surface.

30. The method of claim 24, wherein the rail forms a structured surface, the method further comprising:
coating a silicone or fluorocarbon release material over the structured surface to form a release layer.
